(19) United States
(12) Patent Application Publication
(10) Pub. No.: US 2005/0261003 A1
(43) Pub. Date: Nov. 24, 2005

(54) Call log maps embedded within or provided with telephone and pager billing statements

(76) Inventors: Reno Fiedler, Tucson, AZ (US); Xiaohui Zhang, Tucson, AZ (US)

Correspondence Address: Reno Fiedler, 11303 E Prince Rd, Tucson, AZ, 85749, US

(21) Appl. No.: 10/848,861

(22) Filed: May 20, 2004

(51) Int. Cl. H04M 11/00

(52) U.S. Cl. 455/456.1; 455/435.1; 455/432.1

(57) ABSTRACT

Telephone (installed and mobile) and pager billing statements can be significantly enhanced if the call log information was summarized and presented by visual means, such as maps. A method and system is described herein to deliver telephone and pager call log details through one or more maps embedded within or provided with telephone and pager billing statements. Beyond the traditional tabular call log list, the invented system offers maps, which display the physical locations relevant to calls geo-referenced to a map (location of placement and reception). Calls are represented in the map either individually and/or are summarized by the number of calls, the timing of the calls, the charges applied to the calls, the call categories (incoming, outgoing, daytime, nighttime, peak time, off peak time etc.), local-area and none-local-area calls, sensitive calls, geographic unit, or any combination thereof. A rule system was imposed on an integrated combination of database and geographic information system technology to establish the method and system.

### BACKGROUND OF THE INVENTION

The present invention relates to the field of telephone and pager billing statements. Examples of telephones and pagers include fixed installed phones, mobile cellular phones, calling cards, one-way pagers, two-way pagers, etc. More particularly, this invention relates to the visual presentation of the conducted calls over a certain period of time by maps to summarize the calls by location, amount, category and time, in addition to the conventional tabular call log list in a billing statement. The more intuitive presentation of calls in maps allows the billed entity (person or organization) to identify sensitive or alerting charges more readily. An example of sensitive charges can be a call from a non-local area or a call with a significant charge amount.

Billing statements for telephones and pagers report the calls the billed entity conducted with a list of call date and time, called (outgoing) or calling (incoming) number, category of call, local and non-local identification, and charged amount. With the increasing use of telephone and pager technology, and a large number of people possessing multiple means of electronic communication (such as mobile phones, fixed phones, pagers, . . . ), the tabular billing statements often make it difficult for cardholders to check the detailed calls, which is especially true for multi-page billing statements.

Geographical Information Systems (GIS) in general, and Geo-coding tools in particular, are information systems which can be used to geo-reference caller locations, call locations, or callee information by comparing the available spatial information to other geographically represented information, including street networks and telephone local area (as in area codes), roaming areas, etc. Through such process, geographic coordinates (x, y) or other spatial identifiers (area codes, zip codes, other ids, etc.) can be added to the location. The process of adding additional geographically identifying information is called geo-coding (usually for addresses) or geo-referencing (usually for id based spatial references). With geo-referenced call data, the spatially aware telephone billing system can manage the call information in both relational and spatial dimensions. This spatially aware call system can now be used for analyzing, organizing, and displaying the spatial information in addition to its traditional uses.

The method and system presented herein integrates geo-referencing technology with a telephone or pager billing system. The geo-referenced caller, call, and callee location information is stored, managed and analyzed. The calls are categorized into local-area calls, none-local-area calls, sensitive calls and ordinary ones. Examples of sensitive calls are call with significant charge amounts or calls that have not been placed in the assumed local-area. The GIS produces a set of call maps, which could display the call related locations (origination and reception locations) and summarized calls, thus, improving the quality of service for billed entities as they review their telephone or pager billing statement. This visual representation of calls will aid billed entities to identify fraudulent charges more easily. Ultimately, it will benefit the service provider in consumer studies and customer relationship management.

A GIS tool usually provides maps with very rich colors and symbols in displaying the locations of assets or activities. However, now most of the telephone or pager billing statements are printed in black and white. In order to show all kinds of calls in a call log map only with black and white, special considerations are needed in the map presentations.

We have not seen any publication or patent relating telephone or pager call log maps to billing statements.

### BRIEF SUMMARY OF THE INVENTION

A method and system is described herein to summarize and present telephone and pager calls through one or more maps linked to telephone and pager billing statements. The invention consists of a rule system, the database, and a GIS tool. The invention can be used to communicate calling patterns to callers by call service providers. It can furthermore be used for fraud detection through the use of visualization means other than tables which are often lengthy and hard to comprehend by the caller. Additionally, the presentation of the call log information through alternative means, e.g. maps, has great appeal to customers thus improving the marketing potential of the call service provider to current and future customers.

### BRIEF DESCRIPTION OF THE DRAWINGS

The features and characteristics of call log maps are described in this document. The following figures have been included to aid the understanding of the invention itself and its advantages. These examples are not exhaustive but illustrative of the potential of this invention.

FIG. 1 is one example of a summary call log map. It identifies the charges of this billing period to be from cities in two states, Arizona and New Mexico. It does not label any charges.

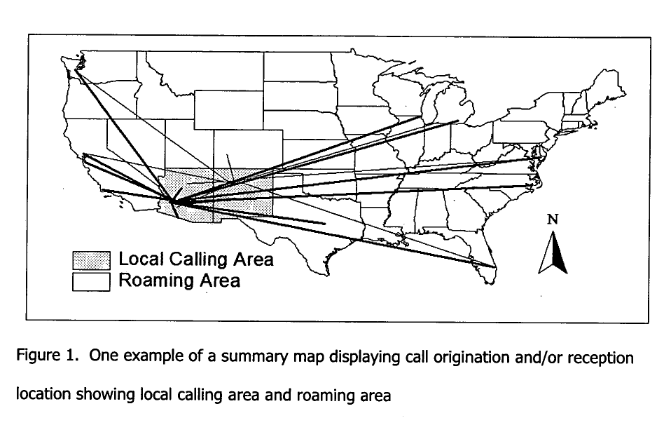

FIG. 2 is one example of a transaction map with a combination of summary labeled long distance/roaming calls and an inset map of the home town and local call origination and/or reception location.

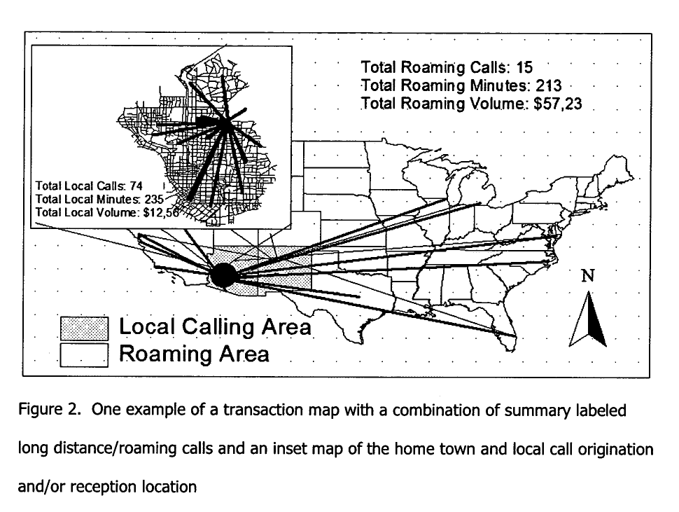

FIG. 3 is one example of two transaction maps displaying outgoing call destinations summarized by state (above) and incoming call origination locations summarized by state (below). The labels contain state name, number of calls placed or received, minutes used, and amount charged.

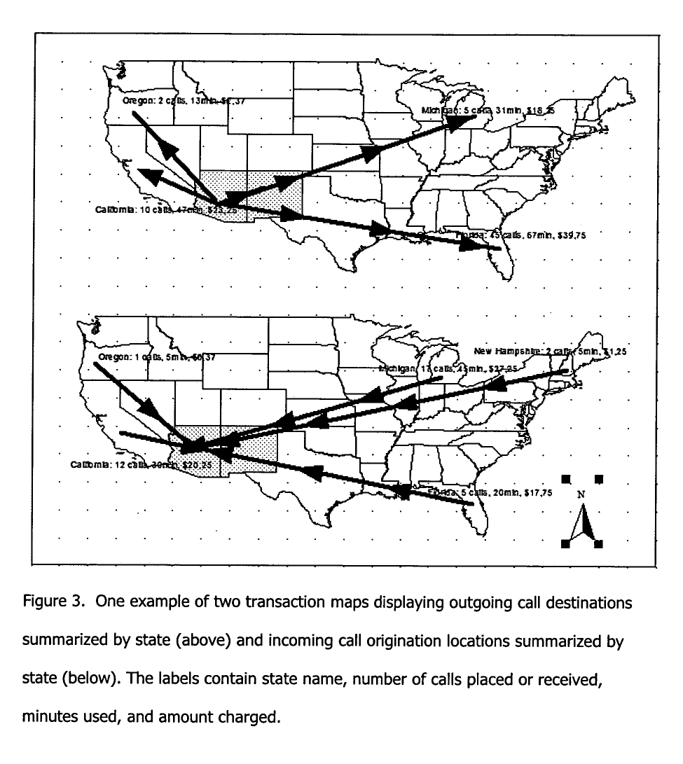

FIG. 4 is one example of a transaction map displaying outgoing calls summarized by reception state with implemented rule based alerting for top three changes measured by number of calls as compared to last month and all 900 calls.

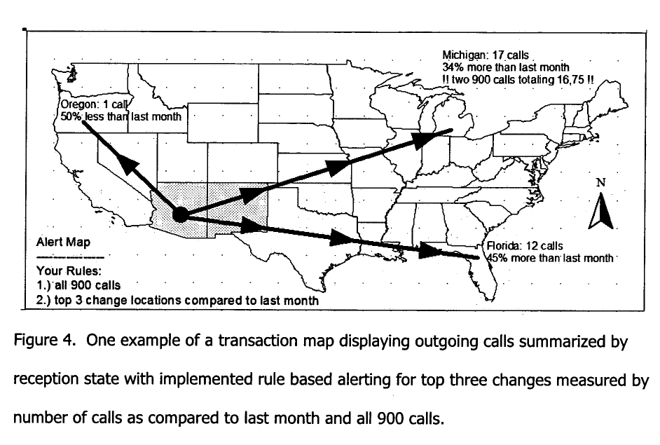

### DETAILED DESCRIPTION

A method and system is described herein to summarize and present telephone and pager calls through one or more maps linked to telephone and pager billing statements.

The invention consists of a rule system, the database, and a GIS tool.

The database stores the records with caller information (such as caller number, caller names, home address, etc.), and the records with call log data (such as the caller and callee ids, transaction number, call date and time, charged amount, call category, caller and callee locations, etc.), and the records with callee information (such as the callee ID, name, address, phone number, etc.). There are four basic call-related location data: caller home location, call origination location, call reception location, and the callee's home location. The latter may not always be available for unknown callers. Call forwarding complicates the assignment of the proper location information, but does not effect the utility of this invention. In the future, the integration of geographic positioning system technology (GPS) into mobile phones and pagers will greatly enhance the accuracy of the call-related location information.

A GIS stores the reference street data or area polygon data to geo-reference call related locations within the United States and other countries. Calls will be geo-referenced on system entry or in a data warehouse, while caller and callee home location information needs only periodic geo-referencing based on reported changes. The GIS tool also produces the transaction maps according to the outputs of the rule system.

The rule system can analyze the calls by call origination and/or reception location and the charged amounts, it can also identify the call areas, category of the calls, and summarize calls by location, by time, by amount, by category, or any combination thereof.

The rule system consists of a set of rules, functions and processes to analyze the caller information, call data, and the callee information.

The rule system interacts with the database and GIS tool. The call data may be read-only, while the location data can be updated through geo-referencing. In the displays of call log maps, the summary of calls can be aggregated into locations. For example, the rule system analyzes the geo-referencing condition for each call-related location, if necessary the rule system will send a message to the geo-referencing tool and let the tool perform the geo-referencing. Another example is that the rule system will send a message to the GIS tool for producing a specific summary call log map in a selected area.

A rule system can have a set of rules to identify the call-related locations, such as the postal zip code, the telephone area code, roaming area codes, and then group them.

An example is to use the local area code (first three digits of 10-digit telephone numbers) in identifying and grouping areas. Another example is to have a map displaying the home location of the billed entity and all the calls conducted in the local area.

A rule system can have a set of rules and processes to identify the number of calls at a location, and summarize the total charged amounts accrued at that location;

A rule system can have a set of rules and processes to sort and rank the charged amounts, and then identify the top-N calls and their locations;

A rule system can have a set of rules and processes to categorize the calls, and summarize the total amounts charged in each category by the call origination and/or reception location. An example is the summary of calls by base rate and location.

A rule system can have a set of rules and processes to categorize and summarize the calls on weekdays or on weekends, and their respective call origination and/or reception location. An example is the summary of calls from and to non-local locations on weekends.

A rule system can have a set of rules and processes to categorize and summarize the calls by day, by week or by the day of week. An example is the summary of calls in the first week by call origination and/or reception location.

A rule system can also handle the combination of above summaries. An example is to summarize the calls on weekends with the amount above $20 on a map of call origination and/or reception location.

In summary, the advantages of the presented invention should be apparent in view of the detailed description provided above. The transaction maps should provide telephone owners with a more intuitive understanding of their spending patterns. These maps also enable the owner to check the location of the calls and, therefore, more easily detect fraudulent use of their cards. Examples of additional benefits to the telephone owner include: how their calling is spatially distributed, where the top-n calls occurred, where are the most frequently called destinations, where the weekend charges occurred, and on what category of call and where they spent significant amounts in that billing period. The benefits to call service providers include but are not limited to better marketing appeal and enhanced service to the clients.

Disclaimer:

While the invention herein disclosed has been described by means of specific applications thereof, numerous modifications and variations could be made thereto by those skilled in the art without departing from the scope of the invention set forth in the claims.

### REFERENCES

Demers, Michael N., “Fundamental of Geographical Information Systems”, John Wiley, 2000;
Grimshaw, David J., “Bring Geographical Information Systems Into Business”, John Wiley, 2000;
Martin, David, “Geographical Information Systems: Socioeconomic Applications”, Routledge, 1996.

1. A method and system for spatially presenting and summarizing telephone (installed and mobile) and pager call logs by call origination and/or reception location, where location is defined as a geographic place, including: address, zip code, roaming area, telephone area codes, provider service network, street network segments for calls from a moving mobile phone, etc. The owner of the telephone or pager is visually alerted of sensitive calls by call log map(s) in telephone and pager billing statements. The method and system is comprised of:
Integration of a database technology, a geographic information system, and a rule system;
Summarizing all or a subset of all calls by a map which displays geo-referenced call origination and/or reception location and/or lines connecting the two places;
Summarizing the charged amounts by call origination and/or reception location within the map;
Summarizing the number of calls by call origination and/or reception location within the map;
Summarizing the categorized calls (incoming, outgoing, daytime, nighttime, peak time, off peak time etc.) by call origination and/or reception location within the map;
Summarizing the calls with significant amounts charged by call origination and/or reception location within a map;
Summarizing the local-area calls by call origination and/or reception location within a map;
Summarizing the none-local-area calls by call origination and/or reception location within a map;
Summarizing weekday calls by call origination and/or reception location within a map;
Summarizing weekend calls by call origination and/or reception location within a map;
Summarizing weekly calls by call origination and/or reception location within a map;
Summarizing calls by applicable base rate (day rate, night rate, peak rate, off peak rate, surcharges, etc.) by call origination and/or reception location within a map;
Including the combination of any of above summary maps.

2. The apparatus as claimed in claim 1, where said summary of calls by call origination and/or reception location within a map includes a map displaying symbols or text denoting the call origination and/or reception location based on geo-referenced information about the originator's and/or the receiver's street address, zip code, city, state, roaming area, telephone codes for each or some calls at that location, where the two locations may be connected via line symbols.

3. The apparatus as claimed in claim 1, where said summary of charged amounts by call origination and/or reception location within a map includes a map displaying symbols or text at the geo-referenced call origination and/or reception location, where the size, the shape, the color, the pattern, labeling text, or any combination thereof reflects the total or a certain range of charged amounts to and/or from that location.

4. The apparatus as claimed in claim 1, where said summary of the number of calls by call origination and/or reception location within a map includes a map displaying symbols or text at the call origination and/or reception location, where the size, the shape, the color, the pattern, labeling text, or any combination thereof reflect the actual number or a certain range of numbers of calls to and/or from that location.

5. The apparatus as claimed in claim 1, where said summary of categorized calls includes a map displaying symbols or text at the call origination and/or reception location, where the size, the shape, the color, the pattern, labeling text, or any combination thereof reflect the categories of incoming, outgoing, daytime, nighttime, peak time, off peak time etc. of calls to and/or from that location.

6. The apparatus as claimed in claim 1, where said summary of sensitive calls includes calls with significant charge amounts, or the call is one among the top-n charged amounts in this billing period.

7. The apparatus as claimed in claim 1, where said summary of local and/or non-local calls includes all locations within or outside, respectively, of the owner's home area, as may be defined by address plus distance function, or any geographic place, including zip code, phone area codes, roaming area codes, service provider network, street network, city or town, county, state, country, continent, etc.

8. The apparatus as claimed in claim 1, where said summary of weekday calls by call origination and/or reception location within a map includes a map displaying symbols or text at the call origination and/or reception location, where the size, the shape, the color, the pattern, labeling text, or any combination thereof reflects calls conducted on weekdays.

9. The apparatus as claimed in claim 1, where said summary of weekend calls by call origination and/or reception location within a map includes a map displaying symbols or text at the call origination and/or reception location, where the size, the shape, the color, the pattern, labeling text, or any combination thereof reflects calls conducted on weekends.

10. The apparatus as claimed in claim 1, where said summary of weekly calls by call origination and/or reception location within a map includes a map displaying symbols or text at the call origination and/or reception location, where the size, the shape, the color, the pattern, labeling text, or any combination thereof reflects calls conducted during the first week, second week, third week and fourth week of the billing period.
